(19) United States
(12) Patent Application Publication
(10) Pub. No.: US 2009/0299979 A1
(43) Pub. Date: Dec. 3, 2009

(54) PRODUCT LIFECYCLE INFORMATION MANAGEMENT SYSTEM USING UBIQUITOUS TECHNOLOGY

(76) Inventors: Suk-hwan Suh, Pohang-si (KR); Byeong Eon Lee, Pohang-si (KR)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 12/474,072

(22) Filed: May 28, 2009

(30) Foreign Application Priority Data
May 30, 2008 (KR) 10-2008-0050782

(51) Int. Cl. G06F 17/30; G06Q 10/00

(52) U.S. Cl. 707/3; 707/104.1; 705/7; 707/E17.044; 707/E17.014; 707/E17.005; 707/E17.107; 707/10

(57) ABSTRACT

A product lifecycle information management system using ubiquitous technology is provided. The system includes a service manager that comprises a service repository for registering a service using product information in a product lifecycle and multiple interface agents (IAs) for providing an interface for the service registered in the service repository. The system further includes multiple neighboring units that are connected to the service manager in order to register the service in the service manager and provide the service or that use the service registered in the service manager. The neighboring units include an integrated data storage for storing an integrated product lifecycle data model and ontology data, a Device to Ubiquitous (D2U) interface unit for providing an interface with a ubiquitous apparatus, and an external system interface unit for providing interfaces with a user terminal and an external application system.

### BACKGROUND

The present invention relates to a product lifecycle information management system using ubiquitous technology and, more particularly, to a product lifecycle information management system that integrates and stores product use information that is obtained and collected from a shop floor in real time using ubiquitous technology.

Due to computer and Internet technology that has developed since the late 20th century, manufacturing fields have been globalize and specialized and an e-Manufacturing paradigm enabling Design-Anywhere Build-Anywhere (DABA) has appeared.

E-Manufacturing has enabled global manufacturing throughout the world, by which designing, manufacturing, and selling are performed and information is interchanged using information technology (IT). The e-Manufacturing has opened a digital manufacturing era in which information is digitalized so as to virtually simulate and analyze manufacturing processes of products from designing to manufacturing using computers.

Enterprise business environments have been changed into user- and participation-focused environments representative of Web 2.0, and the world has importantly recognized environmental problems. Thus, policies for making manufacturers responsible for recycling and disusing steps of products, such as Waste Electrical and Electronic Equipment Directive (WEEE), Extended Producer Responsibility (EPR), End of Life Vehicles Directive (ELV), or the like have been propelled or reinforced.

These social changes demand expansions and renovations of manufacturing fields. In other words, manufacturers are required to design and manufacture products on client demands through information shares and participations of external subjects, such as clients of the manufacturers. Simultaneously, responsibilities and management fields of the manufacturers are required to be extended to lifecycles of products including designing, manufacturing, maintaining, and disusing of the products.

However, it is difficult to appropriately meet backgrounds of the times or needs of manufacturing fields using only the e-Manufacturing paradigm. In other words, the e-Manufacturing paradigm pursues only manufacturing in shop floors and related solutions such as product data management (PDM), product lifecycle management (PLM), and the like function as information systems that support collaborations in processes of manufacturing products. Thus, improvement of a process from a designing step to a manufacturing step and information interchange management may be relatively well performed. However, participants in whole lifecycles of products (in particular, clients) limitedly or difficultly access information necessary for participating in manufacturing activities. As a result, a comprehensive information collection from product selling to product disusing is limited. Also, generation of information about situations of shop floors may delayed by input omissions, delays, and the like of workers in the shop floors and the information may be interchanged only in limited spaces in which the Internet is installed.

Modern society has entered ubiquitous society throughout the life area due to the rapid development of computer, mobile, network, and system integration technologies. Various types of computers that have penetrated into things and environments will be connected to one another through a network in the ubiquitous society to improve qualities of lives. Ubiquitous technology has been applied to various fields such as u-City, u-Home, u-Office, u-Campus, u-Government, u-Health, and the like and will greatly affect manufacturing businesses.

According to characteristics of ubiquitous environments in manufacturing fields, the ubiquitous environments informative situations occurring during product lifecycles based on products differently from other human-based fields. The ubiquitous environments make decisions respectively appropriate for the products. Therefore, the ubiquitous technology in the manufacturing fields will be settled as core technology for resolving many problems that have been unsolved due to technological difficulty. In particular, an information interchange range extends up to worker and material units and information is easily interchanged among workers, equipment, products, and systems anytime, anywhere. Also, real-time information recognition and trace with respect to each product become possible and information is fed back in whole product lifecycles through collection and sharing of history information of each product.

Accordingly, there is required a product lifecycle information management system that reflects backgrounds of the times and demands of manufacturing fields as described above and systematically applies ubiquitous technology to generate shop floor situation information in real time and freely interchange the shop floor situation information anytime, anywhere so as to utilize information obtained throughout the whole lifecycle of a product in a manufacturing site.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

A product lifecycle information management system is provided to integrate and store product use information that is obtained and collected from a shop floor in real-time using ubiquitous technology and product information that is obtained in each step of a product lifecycle, including designing, manufacturing, using, maintaining, repair, recycling, and disusing, as a standardized data model, and provides various heterogeneous systems possessed by participants in the product lifecycle with a standardized interface for accessing the integrated product information so as to collect and use product information and surroundings information of each product anytime, anywhere and to enable real-time collaborations among the participants using the standardized product information in distributed environments.

According to an aspect of one embodiment, it is provided a product lifecycle information management system using ubiquitous technology, including: a service manager that includes a service repository that registers a service using product information in a product lifecycle to store a service description of the registered service and a plurality of interface agents (IAs) that are connected to the service repository to provide an interface for the service registered in the service repository; and a plurality of neighboring units that are connected to the service manager in order to register the service in the service manager and provide the service or that use the service registered in the service manager, wherein the plurality of neighboring units include an integrated data storage that stores an integrated product lifecycle data model and ontology data; a Device to Ubiquitous (D2U) interface unit that provides an interface with a ubiquitous apparatus; and an external system interface unit that provides interfaces with a user terminal and an external application system.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 illustrates a product lifecycle information management concept according to an embodiment of the present invention;

FIG. 2 illustrates service-oriented architecture (SOA) according to an embodiment of the present invention;

FIG. 3 is a block diagram of a product lifecycle information management system according to an embodiment of the present invention;

FIG. 4 illustrates a common detailed structure of each of interface agents (IAs) of FIG. 3, according to an embodiment of the present invention; and

FIG. 5 illustrates a process of operating a product lifecycle information management system according to an embodiment of the present invention.

### DETAILED DESCRIPTION

The present invention will now be described more fully with reference to the accompanying drawings in which exemplary embodiments of the present invention are shown.

A product lifecycle information management system according to some embodiments synthetically manages all types of data regarding designing, manufacturing, using, and recycling of a product, wherein all types of data are collected throughout the whole lifecycle of the product. Thus, characteristics of product lifecycle information that are to be managed will now be described in brief.

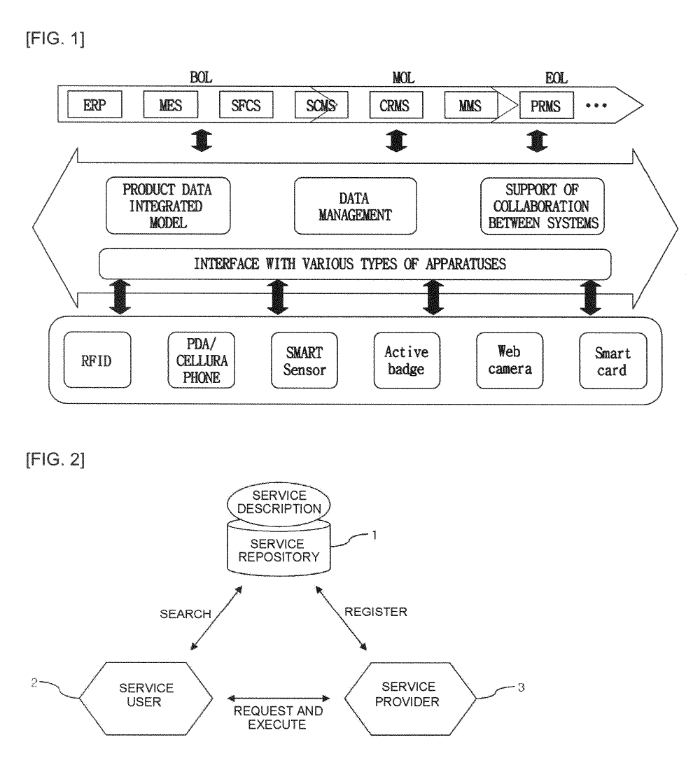

FIG. 1 illustrates a product lifecycle information management concept according to an embodiment of the present invention.

In general, as shown in FIG. 1, a lifecycle of a product is divided into three steps, i.e., Begin-of-Life (BOL), Middle-of-Life (MOL), and End-of-Life (EOL). The BOL includes steps from designing of the product to manufacturing of the product. The MOL includes steps occurring in use of the product (from using of the product by a client to maintenance of the product). The EOL includes recovering and recycling steps of the product that has had its life.

In one embodiment of the subject matter, an information network and a product data integrated model are built to obtain product information throughout the lifecycle of the product so as to smoothly support collaboration between systems. Here, the information network is to obtain product designing- and manufacturing-related information in the BOL step and product history information in the MOL and EOL steps after the product has been sold. Also, the product data integrated model is to integrate and manage product-related data that is obtained from application systems possessed by various participants in the lifecycle of the product, i.e., a manufacturer, a seller, a client, a maintainer, a recycler, etc.

In addition, physical data regarding each product in the MOL and EOL steps is obtained using a radio frequency identification (RFID) tag, a wireless communication, and an embedded system. Further, various types of data about a shop floor are collected in real-time using ubiquitous sensor network (USN) technology in order to accurately manage history information of each product throughout the whole lifecycle of each product.

Various participants use different types of software on heterogeneous platforms used by different types of apparatuses in a product lifecycle. Thus, it is very difficult to build a system that integrates various types of product-related data throughout the whole product lifecycle and secures interoperability with application systems of the participants.

There is a method of using middleware technology such as a Common Object Request Broker Architecture (CORBA), Remote Method Invocation (RMI), or the like in order to secure interoperability among various types of application systems. However, only when the application systems use the same middleware, the middleware technology secures the interoperability. It is difficult to apply the same middleware in various types of system environments of participants in a product lifecycle. As a result, in the present invention, a Service-oriented Architecture (SOA) is used to secure interoperability among different types of systems.

FIG. 2 illustrates an SOA according to an embodiment of the present invention.

The SOA of the present embodiment refers to a new computing paradigm that provides a design framework that integrates distributed applications. As shown in FIG. 2, the core of the SOA is to realize a specific function using a service concept on a network.

A service in the SOA refers to an independent function appearing on a network. An access to the service is possible only through a service description that describes how the service functions and how the service interacts with another one. The service description has a protocol and a data format that comply with open type standards. Thus, a client may use a specific service using standardized protocol and data format of the service description. In other words, when a service provider 3 registers the specific service in a service repository 1, a service user 2 searches the service repository 1 for the specific service to request the service provider 3 to provide the specific service.

In the present invention, services related to a product lifecycle information management are defined based on such an SOA and service providers and service users are defined, respectively, for the services in order to constitute a product lifecycle information management system.

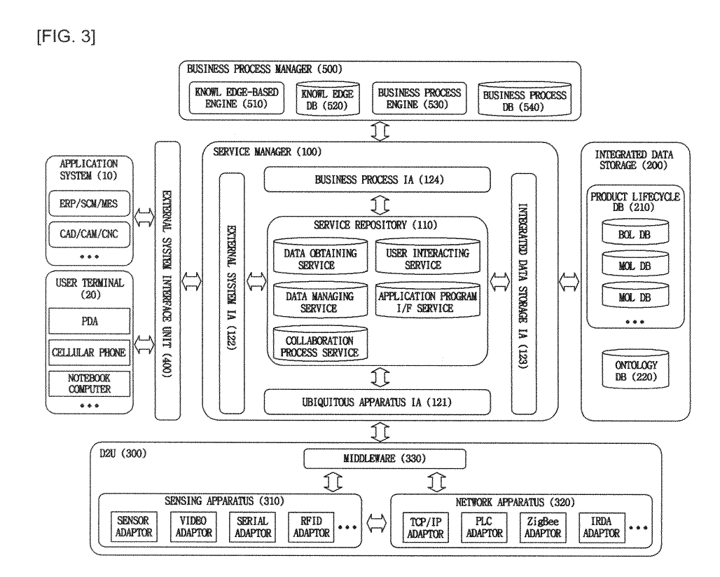

FIG. 3 is a block diagram of a product lifecycle information management system according to an embodiment of the present invention.

As shown in FIG. 3, the product lifecycle information management system according to the present embodiment includes a service manager 100 and a plurality of neighboring units 200, 300, 400, and 500. The service manager 100 registers and stores various types of services that use product information in a product lifecycle and provides interfaces for the registered services. The plurality of neighboring units 200, 300, 400, and 500 are connected to the service manager 100.

Since the present invention is based on an SOA as described above, the service manager 100 is connected to the plurality of neighboring units 200, 300, 400, and 500 to manage information regarding the various types of services using the product lifecycle information and provide corresponding services to the plurality of neighboring units 200, 300, 400, and 500. The plurality of neighboring units 200, 300, 400, and 500 connected to the service manager 100 correspond to service providers and service users on an SOA.

The plurality of neighboring units 200, 300, 400, and 500 respectively refer to an integrated data storage (200), a Device to Ubiquitous (D2U) interface unit (300), an external system interface unit (400), and a business process manager (500). The integrated data storage 200 stores an integrated product lifecycle data model and ontology data. The D2U interface unit 300 provides an interface with a ubiquitous apparatus. The external system interface unit 400 provides an interface between a user terminal 20 and an external application system 10, i.e., between application systems possessed by participants in the product lifecycle. The business process manager 500 defines a business process and performs knowledge-based reasoning. Functions of the neighboring units 200, 300, 400, and 500 as the service providers will now be described.

The integrated data storage 200 performs functions of various databases (DBs) for providing data management services. The D2U interface unit 300 provides a data obtaining service through the ubiquitous apparatus (an RFID, a sensor network, a Web camera, or the like). The external system interface unit 400 provides interface services between the user terminal 20 and the application system 10 and services in order to perform a job requested by a user. The business process manager 500 includes business-related techniques for providing a collaboration process service between systems.

The service manager 100 is a set of interface functions that support the user terminal 20 and the application system 10 connected to the service manager 100 through the network so as to perform services requested by the participants in the product lifecycle. The service manager 100 includes a service repository 110 and a plurality of interface agents (IAs) 121, 122, 123, and 124. The service repository 110 stores service specifications about services registered by the neighboring units 200, 300, 400, and 500. The plurality of IAs 121, 122, 123, and 124 are connected to the service repository 110 to provide service users with interfaces of specific services registered in the service repository 110.

The services registered in the service repository 110 include a data obtaining service, a data managing service, a collaborating process service, a user interacting service, and an application system interfacing service. The data obtaining service is to obtain and provide real-time data and the data managing service is to provide data storing, obtaining, and transmitting functions to all of the participants in the product lifecycle. The collaborating process service is to define business processes and steps of each of the business processes as service forms in order to support the business processes among companies. The user interacting service is to assist workers to communicate with other participants using various types of computing apparatuses. The application system interfacing service is to divide various types of application systems 10 into sub-systems or sub-functions in order to provide interfaces for using the sub-systems or sub-functions. Here, the service repository 110 may store the service descriptions of the services registered in the service repository 110 as standardized protocols such as a Web Service Description Language (WSDL) so that the IAs 121, 122, 123, and 124 analyze the service descriptions.

The IAs 121, 122, 123, and 124 respectively refer to a ubiquitous apparatus IA (121), an external system IA (122), an integrated data storage IA (123), and a business process IA (124). The ubiquitous apparatus IA 121 is positioned between the D2U interface unit 300 and the service manager 100 to connect other neighboring units (e.g., the external system interface unit 400) requesting product data that is used to the D2U interface unit 300. The external system IA 122 is positioned between the external system interface unit 400 and the service manager 100 so as to connect the user terminal 20 or the application system 10 of a human worker to other neighboring units. The integrated data storage IA 123 interchanges local data (used by the application system 10 of the participants) with the integrated data stored in the integrated data storage 200. The business process IA 124 is connected to the business process manager 500 to connect the business process manager 500 to other neighboring units requesting information about the business processes and related knowledge.

The integrated data storage IA 123 provides a service that defines a mapping relation between a local data model and an integrated data model. The IAs 121, 122, 123, and 124 search the service repository 110 for a service requested by a user to provide the user with the service and request a related service provider of the corresponding service according to a service description of the corresponding service stored in the service repository 110. Here, structures of the IAs 121, 122, 123, and 124 will be described in detail later.

The D2U interface unit 300 refers to a neighboring unit that obtains product data that is used during the whole product lifecycle and transmits the product data to the neighboring units. The D2U interface unit 300 includes a sensing apparatus 310, a network apparatus 320, and a middleware 330.

The sensing apparatus 310 includes an embedded apparatus adaptor, an RFID adaptor, an active badge adaptor, a multifunctional sensor adaptor, a smart card adaptor, and the like to sense environments and products in a shop floor so as to collect shop floor data and product data obtained in MOL/EOL steps. The network apparatus 320 collects the data obtained by the sensing apparatus 310 through a wire and wireless interface and includes wire network adaptors such as a transmission control protocol-internet protocol (TCP/IP) adaptor, a power line cable (PLC) adaptor, and the like, and wireless network adaptors such as a ZigBee adaptor, an infrared data association (IrDA) adaptor, a wireless personal area network (WPAN) adaptor, a wireless local area network (WLAN) (IEEE802.11) adaptor, a wireless metropolitan area network (WMAN) (wireless broadband (WIBRO)) adaptor, and the like. The middleware 330 collects and filters unprocessed data obtained from the sensing apparatus 310 and transmits the collected and filtered data to the other neighboring units.

The integrated data storage 200 stores the integrated data, which has been designed based on the product lifecycle integrated data model, and provides an ontology service between the local data and the integrated data through authentication and security processes. The integrated data storage 200 includes a product lifecycle DB 210 (including BOL, MOL, and EOL DBs) that is designed based on the product lifecycle integrated data model and an ontology DB 220, which stores the mapping relation between the integrated data and the local data stored in the product lifecycle DB 210.

The product lifecycle integrated data model may be generated in each of the steps of the product lifecycle using a function modeling technique that is defined by Integration Definition for Function Modeling (IDEF0). The product lifecycle integrated data model may be designed to be compatible with existing international standards, such as International Standardization Organization (ISO) 10303 STEP, ISO 15531 MANDATE, or ISO 14649 STEP-NC, for ontology integration. Elements of the product lifecycle integrated data model will now be described in each step of the product lifecycle. In the BOL step, the product lifecycle integrated data model includes data related to product designing and manufacturing such as information regarding detailed specifications, parts, assembling, and disassembling of a product, and kinematics information. In the MOL step, the product lifecycle integrated data model includes activity information related to maintenance, diagnosis, and product use, observation information regarding collected product states, and fault information related to faults in the product. In the EOL step, the product lifecycle integrated data model includes information related to product recovery and disuse such as reproducing, repairing, recycling, disusing, or the like.

The business process manager 500 includes a knowledge-based engine 510, a knowledge DB 520, a business process engine 530, and a business process DB 540. Thus, the business process manager 500 defines a business process and performs knowledge-based reasoning to provide a collaborating process service between systems. The business process manager 500 may be installed as an additional business process management system outside the product lifecycle information management system of the present invention.

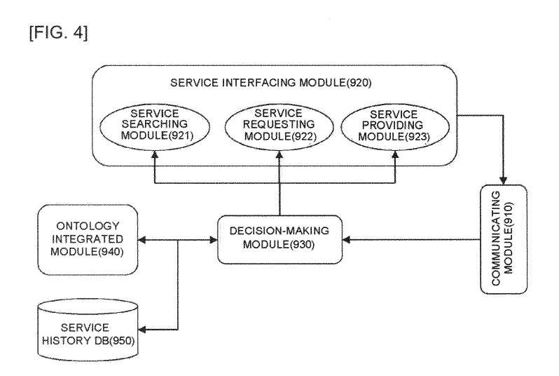

FIG. 4 illustrates a common detailed structure of each of the IAs 121 of FIG. 3, according to an embodiment of the present invention.

The common detailed structure of each of the IAs 121, 122, 123, and 124 that has been described above will now be described. As shown in FIG. 4, each of the IAs 121, 122, 123, and 124 includes a communicating module 910, a service interfacing module 920, and a decision-making module 930. The communicating module 910 receives a service request message for requesting service searching or service providing from the outside. The service interfacing module 920 provides a requested service with reference to the service repository 110. The decision-making module 930 analyzes the service request message transmitted through the communicating module 910 to control the service interfacing module 920 so as to perform a function corresponding to the service request message. Each of the IAs 121, 122, 123, and 124 also includes an ontology integrating module 940 and a service history DB 950. The ontology integrating module 940 defines a relation between the integrated product lifecycle data model stored in the integrated data storage 200 and the local data model in order to provide a standard for transforming data provided through a service into data complying with data standards of a service user. The service history DB 950 stores histories of services performed by the IAs 121, 122, 123, and 124.

The service interfacing module 920 includes a service searching module 921 that searches for a service, a service requesting module 922 that requests the service, and a service providing module 930 that provides the service. The service searching module 921, the service requesting module 922, and the service providing module 923 may use a standardized protocol such as a Simple Object Access Protocol (SOAP) as a message protocol and a Web Service Description Language (WSDL) defined in an Extensible Markup Language (XML) as a service description language.

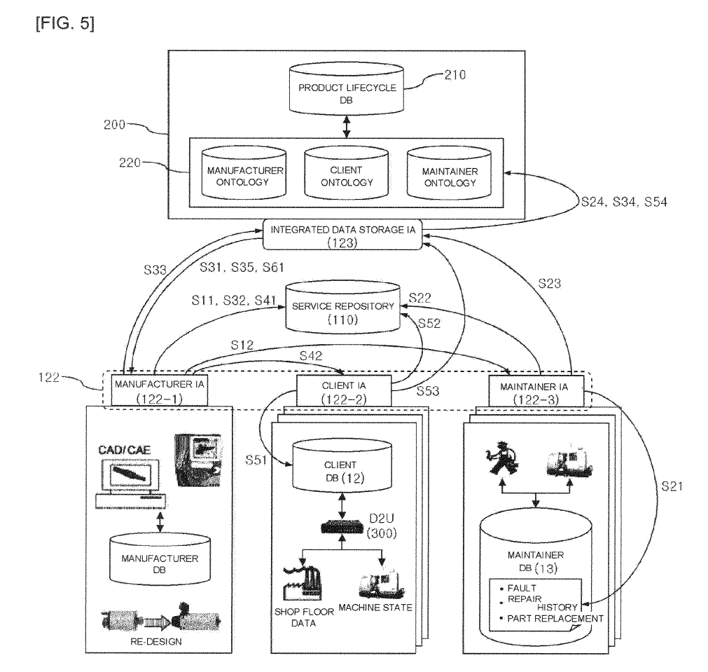

FIG. 5 illustrates a process of operating a product lifecycle information management system according to an embodiment of the present invention.

An operation process of the product lifecycle information management system of the present embodiment that is applied to a product lifecycle information management of a machine tool and provides a product designer with an information providing service will now be described with reference to FIG. 5.

A participant in a product lifecycle related to the machine tool may be a designer of a manufacturer, a user of a client, or a maintainer of a maintaining company. Here, a product designer who professionally designs a spindle of a machine tool having 20,000 revolutions per minute (RPM) or more will be considered as the participant in the product lifecycle.

When an MTB, a machine worker, or a machine tool maintainer receives some complaints about products after the products are marketed, a product designer generally finds a solution, mainly using know-how or a DB of the product designer with reference to direct and indirect complaints of clients transmitted from salespeople or an AS team. In particular, the product designer or a test evaluation expert tested products without considerations for real use environments of the spindle of the machine tool, e.g., a type of the machine tool, cutting conditions, a temperature in a shop floor, and the like. Thus, the rapid, accurate resolutions of the received complaints were limited.

When the product lifecycle information management system according to the present invention is applied as shown in FIG. 5, an application system of a manufacturer used by a product designer may further effectively improve a design of a product using various types of product-related information stored in a system of another participant in a remote place through the external system IA 122 providing interfaces among application systems of participants, i.e., a manufacturer IA 122-1, a client IA 122-2, and a maintainer IA 122-3. This process will now be described in detail.

The product designer receives a reference command to a product repair history including fault information about a spindle unit from several maintainers using an application system of the product designer, e.g., computer-aided design (CAD), computer-aided engineering (CAE), or the like. The application system is connected to the service repository 110 through the manufacturer IA 122-1 in response to the reference command in order to request a product repair history reference service. Here, a process of operating detailed modules of the manufacturer IA 122-1 will now be described. In operation S11, the service searching module 921 searches the service repository 110 for a corresponding service. In operation S12, the decision-making module 930 activates the service requesting module 922 with reference to a service description of the searched service in order to request the maintainer IA 122-3 of a product repair history transmission service.

In operation S21, the maintainer IA 122-3 searches a maintainer DB 13 for corresponding information and reads the corresponding information from the maintainer DB 13 in response to the service request of the manufacturer IA 122-1. In operation S22, the maintainer IA 122-3 searches the service repository 110 for an information transformation service in order to transform the read information into standardized information defined by an integrated data model. In operation S23, the maintainer IA 122-3 requests the integrated data storage 200, which is a service provider of the corresponding service, of the information transformation service through the integrated data storage IA 123. In operation S24, the integrated data storage IA 123 obtains the standardized information from a maintainer ontology DB of the ontology DB 220 in response to the request for the information transformation service. In operation S31, the integrated data storage IA 123 transmits standardized product repair history information to an initial service requester, i.e., the manufacturer IA 122-1.

In operation S32, the manufacturer IA 122-1 refers to a service description of the corresponding information transformation service in the service repository 110 in order to transform the standard product repair history information into local form information used in an application system of a manufacturer. In operation S33, the manufacturer IA 122-1 requests the integrated data storage 200, which is the service provider of the corresponding service, of the information transformation service.

In operation S34, the integrated data storage IA 123 obtains the local form information from the manufacturer ontology DB of the ontology DB 220 in response to the request for the information transformation service. In operation S35, the integrated data storage IA 123 transmits the product history information transformed into the local form information to the manufacturer IA 122-1, which is the service requester.

It is assumed that the product designer analyzes information related to product faults based on product repair history information about the spindle in order to conclude that faults in the product have been caused by a thermal deformation of the spindle.

The product designer is required to improve the design of the spindle using a new design concept of improving the thermal deformation and simulate a performance of the spindle in real use conditions and shop floor environments of the spindle in order to evaluate efficiency of the new design concept.

In operation S41, the manufacturer IA 122-1 refers to a service description of a product use information providing service stored in the service repository 110 in order to obtain information about the real use conditions and shop floor environments of the spindle. In operation S42, the manufacturer IA 122-1 requests the information transformation service of a client system, which is a service provider of the corresponding information transformation service, through the client IA 122-2.

In operation S51, the client IA 122-2 reads product use information from the client DB 12 through the D2U interface unit 300. Here, the read product use information includes processing conditions such as a total operating time, a cutting tool, and a material of a processed product and shop floor information such as a temperature, humidity, and vibration of the spindle.

Operations S52, S53, S54, and S61 are sequentially performed to transform the read information into the standardized information defined by the integrated data model so as to provide the standardized information to the manufacturer IA 122-1, which is the service requester. Operations S52, S53, S54, and S61 are separately performed through the same process as that by which operations S22, S23, S 24, and S24 respectively correspond to operations S52, S53, S54, and S61 are performed.

The manufacturer IA 122-1 performs the same operations as operations S32 through 35 to transform the standardized product use information into the local form information so as to provide the local form information to the product designer.

The product designer simulates and analyzes a newly designed spindle under real operation conditions using finally transmitted local form product use information to improve a design of a product so as to accurately solve problems of the product. As a result, the product designer may take effective, accurate actions with respect to various types of product problems through the above-described process.

As described above, a product lifecycle information management system using ubiquitous technology according to the present invention may easily interchange product information among various types of application systems that are distributed in a product lifecycle. Thus, the product lifecycle information management system builds an efficient collaboration system through interchanges of standardized product information among participants using the various types of application systems.

Also, a product designer of a manufacturer may really reflect use conditions and environments in use of a product in order to efficiently improve existing products or develop new products that meet demands of clients.

In addition, a maintainer may recommend upgrades of products appropriate for use environments of the clients or pre-provide necessary services before faults occur in the products, using product use information.

While the present invention has been particularly shown and described with reference to exemplary embodiments thereof, it will be understood by those of ordinary skill in the art that various changes in form and details may be made therein without departing from the spirit and scope of the present invention as defined by the following claims.

The embodiments of the invention in which an exclusive property or privilege is claimed are defined as follows:

1. A product lifecycle information management system using ubiquitous technology, comprising:
a service manager, the service manager comprising:
a service repository that registers a service using product information in a product lifecycle to store a service description of the registered service, and
a plurality of interface agents (IAs) that are connected to the service repository to provide an interface for the service registered in the service repository; and
a plurality of neighboring units, connected to the service manager, for registering the service in the service manager, providing the service or using the service registered in the service manager,
wherein the plurality of neighboring units comprises:
an integrated data storage for storing an integrated product lifecycle data model and ontology data;
a Device to Ubiquitous (D2U) interface unit for providing an interface with a ubiquitous apparatus; and
an external system interface unit for providing interfaces with a user terminal and an external application system.

2. The product lifecycle information management system of claim 1, wherein the service registered in the service repository comprises:
a data obtaining service for obtaining and providing real-time data;
a data managing service for providing data storing, obtaining, and transmitting functions to all of participants in the product lifecycle;
a collaboration process service configured to define business processes and steps of the business processes as service forms in order to support business processes between companies;
a user interacting service for assisting a worker to communicate with another participant using various types of computing apparatuses; and
an application system interfacing service for providing an interface for using an external application system.

3. The product lifecycle information management system of claim 1, wherein the plurality of IAs comprises:
a ubiquitous apparatus IA that is positioned between the D2U interface unit and the service manager in order to connect the neighboring units requesting product data that is used to the D2U interface unit;
an external system IA that is positioned between the external system interface unit and the service manager in order to connect one of the user terminal and the external application system to the other neighboring units; and
an integrated data storage IA that is positioned between the integrated data storage and the service manager in order to provide an interface for mapping between local data stored in the external application system and integrated data stored in the integrated data storage.

4. The product lifecycle information management system of claim 1, wherein the plurality of IAs further comprises a business process IA that connects neighboring units requesting information about knowledge related to the business processes to an external business process management system.

5. The product lifecycle information management system of claim 1, wherein each of the plurality of IAs comprises:
a communicating module for receiving a service request message from an external source;
a service interfacing module for providing a requested service with reference to the service repository; and
a decision-making module for analyzing the service request message transmitted from the communication module to control the service interfacing module so as to perform a function corresponding to the service request message.

6. The product lifecycle information management system of claim 5, wherein the service interfacing module comprises:
a service searching module configured to search for a service;
a service requesting module configured to request the service; and
a service providing module configured to provide the service.

7. The product lifecycle information management system of claim 5, wherein the IAs use a simple object access protocol (SOAP) as a message protocol.

8. The product lifecycle information management system of claim 5, wherein each of the plurality of IAs further comprises:
an ontology integrated module that defines a relation between the integrated product lifecycle data model stored in the integrated data storage and the local data model in order to transform data provided through a service according to data standards of the service of a user; and
a service history database (DB) for storing histories of performed services.

9. The product lifecycle information management system of claim 1, wherein the D2U interface unit comprises:
a sensing apparatus for sensing environments and products in a shop floor to collect shop floor data and product data;
a network apparatus for collecting the shop floor data and the product data obtained by the sensing apparatus through a wire or wireless interface; and
a middleware for collecting and filtering unprocessed data obtained from the sensing apparatus to transmit the collected and filtered data to the neighboring units.

10. The product lifecycle information management system of claim 9, wherein the sensing apparatus comprises at least one or more of an embedded apparatus adaptor, a radio frequency identification (RFID) adaptor, an active badge adaptor, a multifunctional sensor adaptor, and a smart card adaptor.

11. The product lifecycle information management system of claim 9, wherein the network apparatus comprises at least one or more of a transmission control protocol-internet protocol (TCP/IP) adaptor, a power line cable (PLC) adaptor, a ZigBee adaptor, an infrared data association (IrDA) adaptor, a wireless personal area network (WPAN) adaptor, a wireless local area network (WLAN) (IEEE802.11) adaptor, and a wireless metropolitan area network (WMAN) (wireless broadband (WIBRO)) adaptor.

12. The product lifecycle information management system of claim 1, wherein the integrated data storage comprises:
a product lifecycle integrated DB being designed as a product lifecycle integrated model; and
an ontology DB for storing a mapping relation between the integrated data stored in the product lifecycle integrated DB and the local data.

13. The product lifecycle information management system of claim 12, wherein the product lifecycle integrated data model complies with one of International Standardization Organization (ISO) 10303 STEP, ISO 15531 MANDATE, and ISO 14649 STEP-NC.

14. The product lifecycle information management system of claim 1, wherein the service description stored in the service repository complies with Web service description language (WSDL) standards.
